(19) United States
(12) Patent Application Publication
(10) Pub. No.: US 2021/0256993 A1
(43) Pub. Date: Aug. 19, 2021

(54) Voice Separation with An Unknown Number of Multiple Speakers

(71) Applicant: Facebook, Inc., Menlo Park, CA (US)

(72) Inventors: Eliya Nachmani, Jerusalem (IL); Lior Wolf, Herzliya (IL); Yossef Mordechay Adi, New York, NY (US)

(21) Appl. No.: 16/853,320

(22) Filed: Apr. 20, 2020

Related U.S. Application Data
(60) Provisional application No. 62/978,247, filed on Feb. 18, 2020.

(51) Int. Cl. G10L 25/78; G10L 21/0272; G10L 19/008; G06N 3/08; G06N 3/04; G06N 20/20

(52) U.S. Cl. CPC G10L 25/78; G10L 21/0272; G06N 20/20; G06N 3/084; G06N 3/0454; G10L 19/008

(57) ABSTRACT

In one embodiment, a method includes receiving a mixed audio signal comprising a mixture of voice signals associated with a plurality of speakers, generating first audio signals by processing the mixed audio signal using a first machine-learning model configured with a first number of output channels, determining that at least one of the first number of output channels is silent based on the first audio signals, generating second audio signals by processing the mixed audio signal using a second machine-learning model configured with a second number of output channels that is fewer than the first number of output channels, determining that each of the second number of output channels is non-silent based on the second audio signals, and using the second machine-learning model to separate additional mixed audio signals associated with the plurality of speakers.

### PRIORITY

This application claims the benefit under 35 U.S.C. § 119(e) of U.S. Provisional Patent Application No. 62/978,247, filed 18 Feb. 2020, which is incorporated herein by reference.

### TECHNICAL FIELD

This disclosure generally relates to speech processing, and in particular relates to machine learning for such processing.

### BACKGROUND

Machine learning (ML) is the study of algorithms and mathematical models that computer systems use to progressively improve their performance on a specific task. Machine learning algorithms build a mathematical model of sample data, known as “training data”, in order to make predictions or decisions without being explicitly programmed to perform the task. Machine learning algorithms may be used in applications such as email filtering, detection of network intruders, and computer vision, where it is difficult to develop an algorithm of specific instructions for performing the task. Machine learning is closely related to computational statistics, which focuses on making predictions using computers. The study of mathematical optimization delivers methods, theory, and application domains to the field of machine learning. Data mining is a field of study within machine learning and focuses on exploratory data analysis through unsupervised learning. In its application across business problems, machine learning is also referred to as predictive analytics.

Speech processing is the study of speech signals and the processing methods of signals. The signals are usually processed in a digital representation, so speech processing can be regarded as a special case of digital signal processing, applied to speech signals. Aspects of speech processing includes the acquisition, manipulation, storage, transfer and output of speech signals. The input is called speech recognition and the output is called speech synthesis.

### SUMMARY OF PARTICULAR EMBODIMENTS

The embodiments disclosed herein present a new method for separating a mixed audio sequence, in which multiple voices speak simultaneously. The new method employs gated neural networks that are trained to separate the voices at multiple processing steps, while maintaining the speaker in each output channel fixed. A different model is trained for every number of possible speakers, and one or more activity detectors may be used in order to select the right model. The new method greatly outperforms the current state of the art, which, as the embodiments disclosed herein show, is not competitive for more than two speakers.

In particular embodiments, a computing system may receive a mixed audio signal comprising a mixture of voice signals associated with a plurality of speakers. In particular embodiments, the computing system may generate first audio signals by processing the mixed audio signal using a first machine-learning model configured with a first number of output channels. The computing system may then determine, based on the first audio signals, that at least one of the first number of output channels is silent. In particular embodiments, the computing system may generate second audio signals by processing the mixed audio signal using a second machine-learning model configured with a second number of output channels that is fewer than the first number of output channels. The computing system may then determine, based on the second audio signals, that each of the second number of output channels is non-silent. In particular embodiments, the computing system may further use the second machine-learning model to separate additional mixed audio signals associated with the plurality of speakers.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system and a computer program product, wherein any feature mentioned in one claim category, e.g. method, may be claimed in another claim category, e.g. system, as well. The dependencies or references back in the attached claims are chosen for formal reasons only. However any subject matter resulting from a deliberate reference back to any previous claims (in particular multiple dependencies) may be claimed as well, so that any combination of claims and the features thereof are disclosed and may be claimed regardless of the dependencies chosen in the attached claims. The subject-matter which may be claimed comprises not only the combinations of features as set out in the attached claims but also any other combination of features in the claims, wherein each feature mentioned in the claims may be combined with any other feature or combination of other features in the claims. Furthermore, any of the embodiments and features described or depicted herein may be claimed in a separate claim and/or in any combination with any embodiment or feature described or depicted herein or with any of the features of the attached claims.

### BRIEF DESCRIPTION OF THE DRAWINGS

FIG. 1 illustrates an example architecture of the network disclosed herein for voice separation.

FIG. 2 illustrates an example multiply and concatenation (MULCAT) block.

FIG. 3 illustrates example training losses used in the embodiments disclosed herein, shown for the case of two speakers.

FIG. 4 illustrates example training curves of the disclosed model for various kernel sizes.

FIG. 5 illustrates an example fraction of samples in which the model produces output channels with an identity switch, using the dataset of two speakers.

FIG. 6 illustrates an example method for separating mixed voice signals.

FIG. 7 illustrates an example computer system.

### DESCRIPTION OF EXAMPLE EMBODIMENTS

The embodiments disclosed herein present a new method for separating a mixed audio sequence, in which multiple voices speak simultaneously. The new method employs gated neural networks that are trained to separate the voices at multiple processing steps, while maintaining the speaker in each output channel fixed. A different model is trained for every number of possible speakers, and one or more activity detectors may be used in order to select the right model. The new method greatly outperforms the current state of the art, which, as the embodiments disclosed herein show, is not competitive for more than two speakers.

In particular embodiments, a computing system may receive a mixed audio signal comprising a mixture of voice signals associated with a plurality of speakers. In particular embodiments, the computing system may generate first audio signals by processing the mixed audio signal using a first machine-learning model configured with a first number of output channels. The computing system may then determine, based on the first audio signals, that at least one of the first number of output channels is silent. In particular embodiments, the computing system may generate second audio signals by processing the mixed audio signal using a second machine-learning model configured with a second number of output channels that is fewer than the first number of output channels. The computing system may then determine, based on the second audio signals, that each of the second number of output channels is non-silent. In particular embodiments, the computing system may further use the second machine-learning model to separate additional mixed audio signals associated with the plurality of speakers.

The ability to separate a single voice from the multiple conversations occurring concurrently forms a challenging perceptual task. The ability of humans to do so has inspired many computational attempts, with much of the earlier work focusing on multiple microphones and unsupervised learning, e.g., the Independent Component Analysis approach.

The embodiments disclosed herein focus on the problem of supervised voice separation from a single microphone, which has seen a great leap in performance following the advent of deep neural networks. In this “single-channel source separation” problem, given a dataset containing both the mixed audio and the individual voices, one trains to separate a novel mixed audio that contains multiple unseen speakers. In particular embodiments, the first machine-learning model and the second machine-learning model may be each trained based on a plurality of mixed audio signals and a plurality of audio signals associated with each of the plurality of speakers. Each mixed audio signal may comprise a mixture of voice signals associated with the plurality of speakers.

The current leading methodology is based on an overcomplete set of linear filters, and on separating the filter outputs at every time step using a binary or continuous mask for two speakers, or a multiplexer for more speakers. The audio is then reconstructed from the partial representations. Since the order of the speakers is considered arbitrary (it is hard to sort voices), one uses a permutation invariant loss during training, such that the permutation that minimizes the loss is considered.

The need to work with the masks, which becomes more severe as the number of voices to be separated increases, is a limitation of this masking-based method. The embodiments disclosed herein therefore set to build a mask-free method. In particular embodiments, the first machine-learning model and the second machine-learning model may be each based on one or more neural networks. The method may employ a sequence of RNNs that are applied to the audio. As the embodiments disclosed herein show, it may be beneficial to evaluate the error after each RNN, obtaining a compound loss that reflects the reconstruction quality after each layer.

The RNNs may be bi-directional. Each RNN block may be built with a specific type of residual connection, where two RNNs run in parallel and the output of each layer is the concatenation of the element-wise multiplication of the two RNNs with the input of the layer that undergoes a bypass (skip) connection.

Since the outputs are given in a permutation invariant fashion, voices may switch between output channels, especially during transient silence episodes. In order to tackle this, the embodiments disclosed herein propose a new loss that is based on a speaker voice representation network that is trained on the same training set. The embedding obtained by this network is then used to compare the output voice to the voice of the output channel. The embodiments disclosed herein demonstrate that the loss is effective, even when adding it to the baseline method. An additional improvement, that is effective also for the baseline methods, is obtained by starting the separation from multiple locations along the audio file and averaging the results.

Similar to the state-of-the-art methods, the embodiments disclosed herein train a single model for each number of speakers. The gap in performance of the obtained model in comparison to the literature methods increases as the number of speakers increases, and one can notice that the performance of our method degrades gradually, while the baseline methods show a sharp degradation as the number of speakers increases.

In particular embodiments, a number of the plurality of speakers may be unknown. To support the possibility of working with an unknown number of speakers, the embodiments disclosed herein opt for a learning-free solution and select the number of speakers by running a voice-activity detector on its output. This simple method may be able to select the correct number of speakers in the vast majority of the cases and leads to the disclosed method being able to handle an unknown number of speakers.

The contributions of the embodiments disclosed herein may include: (i) a novel audio separation model that employs a specific RNN architecture, (ii) a set of losses for effective training of voice separation networks, (iii) performing effective model selection in the context of voice separation with an unknown number of speakers, and (iv) state of the art results that show a sizable improvement over the current state of the art in an active and competitive domain.

In the problem of single-channel source separation, the goal is to estimate C different input sources sⱼϵ [symbol] ^{T}, where jϵ[1, . . . , C], given a mixture x=Σᵢ₌₁^{c}cᵢsᵢ where cᵢ is a scaling factor. The input length, T, is not a fixed value, since the input utterances can have different durations. The embodiments disclosed herein focus on the supervised setting, in which a training set S={xᵢ, (s_{i,1}, . . . s_{i,C})}ᵢ₌₁ⁿ is provided, and the goal is to learn the model that given an unseen mixture x outputs C estimated channels ŝ=(ŝ₁, . . . , ŝ_{C}) that maximize the scale-invariant source-to-noise ratio (SI-SNR) (also known as the scale-invariant signal-to-distortion ratio, SI-SDR for short), between the predicted and the target utterances. More precisely, since the order of the input sources is arbitrary and since the summation of the sources is order invariant, the goal is to find C separate channels s that maximize the SI-SNR to the ground truth signals, when considering the reorder channels (ŝ_{π(1)}, . . . , ŝ_{π(C)}) for the optimal permutation π.

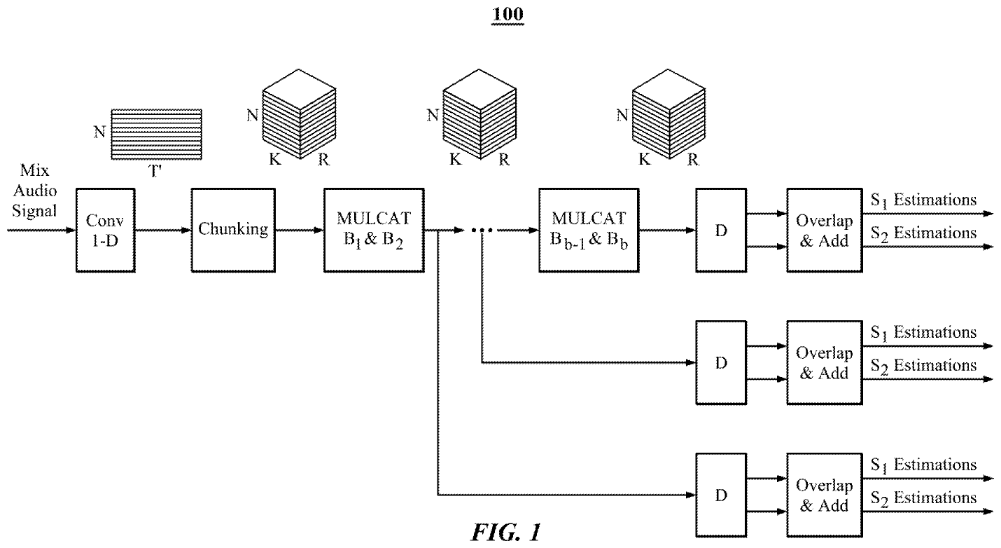

FIG. 1 illustrates an example architecture 100 of the network disclosed herein for voice separation. The proposed model, depicted in FIG. 1, is inspired by the recent advances in speaker separation models. The first steps of processing, including the encoding, the chunking, and the two bi-directional RNNs on the tensor that is obtained from chunking are similar. However, the RNNs disclosed herein contain dual heads, the embodiments disclosed herein do not use masking, and the losses used are different. FIG. 1 illustrates that the audio is being convolved with a stack of 1D convolutions and reordered by cutting overlapping segments of length K in time, to obtain a 3D tensor. b RNN blocks are then applied, such that the odd blocks operate along the time dimension and the chunk length dimension. In the disclosed method, the RNN blocks are of the type of multiply and add. After each pair of blocks, the embodiments disclosed herein apply a convolution D to the copy of the activations, and obtain output channels by reordering the chunks and then using the overlap and add operator.

In particular embodiments, the computing system may encode the mixed audio signal to generate a latent representation. First, an encoder network, E, gets as input the mixture waveform xϵ [symbol] ^{T} and outputs a N-dimensional latent representation z of size T′=(2T/L)−1, where L is the encoding compression factor. This results in zϵ [symbol] ^{N×T′},

z=E(x) (1)

Specifically, E is a 1-D convolutional layer with a kernel size L and a stride of L/2, followed by a ReLU non-linear activation function. In other words, encoding the mixed audio signal may be based on one or more convolution operations.

In particular embodiments, the computing system may further generate a three-dimensional (3D) tensor based on the latent representation. The generation may comprise dividing the latent representation into a plurality of overlapping chunks and concatenating the plurality of overlapping chunks along one or more singleton dimensions. The latent representation z is then divided into R=[2T′/K]+1 overlapping chunks of length K and hop size P, denoted as uᵣ ϵ [symbol] ^{N×K}, where rϵ[1, . . . , R]. All chunks are then being concatenated along the singleton dimensions and the embodiments disclosed herein obtain a 3-D tensor v=u₁ . . . , u_{R}]ϵ [symbol] ^{N×K×R}.

Next, v is fed into the separation network Q, which consists of b RNN blocks. The odd blocks B₂ᵢ₋₁ for i=1, . . . , b/2 apply the RNN along the time-dependent dimension of size R. The even B₂ᵢ blocks are applied along the chunking dimension of size K. Intuitively, processing the second dimension yields a short-term representation, while processing the third dimension produce long-term representation.

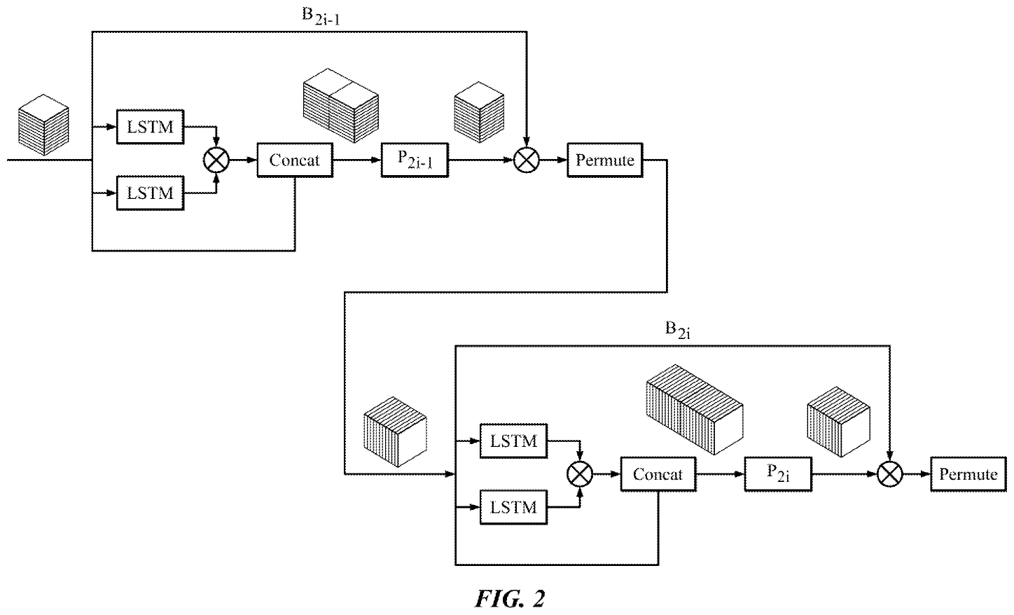

FIG. 2 illustrates an example multiply and concatenation (MULCAT) block. In particular embodiments, the first machine-learning model and the second machine-learning model may be each based on one or more multiply-and-concatenation (MULCAT) blocks. Each MULCAT block may comprise one or more of a long-short term memory (LSTM) unit, a concatenation operation, a linear projection, or a permutation operation. The RNN blocks disclosed herein contain the MULCAT block with two sub-networks and a skip connection. Consider, for example, the odd blocks Bᵢ i=1, 3, . . . , b−1. The embodiments disclosed herein employ two separate bidirectional LSTM, denoted as Mᵢ¹ and Mᵢ², element wise multiply their outputs, and finally concatenate the input to produce the module output.

Bᵢ(v)=Pᵢ([Mᵢ¹(v)⊙Mᵢ²(v),v]) (2)

where ⊙ is the element wise product operation, and Pᵢ is a learned linear project that brings the dimension of the result of concatenating the product of the two LSTMs with the input v back to the dimension of v. A visual description of a pair of blocks is given in FIG. 2. In the odd blocks, the 3D tensor obtained from chunking is fed into two different bi-directional LSTMs that operate along the second dimension. The results are multiplied element-wise, followed by a concatenation of the original signal along the third dimension. A learned linear projection along this dimension is then applied to obtain a tensor of the same size of the input. In the even blocks, the same set of operations occur along the chunking axis.

In the method disclosed herein, the embodiments disclosed herein employ a multiscale loss, which requires reconstructing the original audio after each pair of blocks. The 3D tensor undergoes the PReLU non-linearity with parameters initialized at 0.25. Then, a 1×1 convolution with CR output channels D. The resulting tensor of size N×K×CR is divided into C tensors of size N×K×R is that would lead to the C output channels. Note that the same PReLU parameters and the same convolution D are used to decode the output of every pair of MUL-CAT blocks.

In order to transform the 3D tensor back to audio, the embodiments disclosed herein employ the overlap and add an operator to the R chunks. The operator, which inverts the chunking process, adds overlapping frames of the signal after offsetting them appropriately by a step size of L/2 frames.

Recall that since the identity of the speakers is unknown, the goal is to find C separate channels ŝ that maximize the SI-SNR between the predicted and target signals. Formally, the SI-SNR is defined as

$$SI \text{-} SNR ( s , \hat{s} ) = 10 {log}_{10} \frac{{‖ {\hat{s}}_{i} ‖}^{2}}{{‖ {\tilde{e}}_{i} ‖}^{2}} \\ where , {\tilde{s}}_{i} = \frac{( {s}_{i} {\hat{s}}_{i} ) {s}_{i}}{{‖ {s}_{i} ‖}^{2}} , and {\tilde{e}}_{i} = {\hat{s}}_{i} - {\tilde{s}}_{i} . \qquad ( 3 )$$

Since the channels are unordered, the loss is computed for the optimal permutation π of the C different output channels and is given as:

$$l ( s , \hat{s} ) = - {max}_{π ∈ {\prod }_{C}} \frac{1}{c} {\sum }_{i = 1}^{C} SI - SNR ( s , {\hat{s}}_{π ( i )} ) \qquad ( 4 )$$

where II_{C} is the set of all possible permutations of 1 . . . C. The loss l(s, ŝ) is often denoted as the utterance level permutation invariant training (uPIT).

As stated above, the convolution D is used to decode after every MULCAT block, allowing us to apply the uPIT loss multiple times along the decomposition process. Formally, the model disclosed herein outputs b/2 groups of output channels {ŝⱼ}ⱼ₌₁^{b/2} and the embodiments disclosed herein consider the loss

$$ℓ ( s , {\{ {\hat{s}}_{j} \}}_{j = 1}^{b / 2} = \frac{1}{b} {\sum }_{j = 1}^{b / 2} ℓ ( s , {\hat{s}}_{j} ) \qquad ( 5 )$$

Notice that the permutation of π the output channels may be different between the components of this loss. In particular embodiments, the computing system may determine a permutation for the second number of output channels based on a permutation invariant loss function.

Speaker Classification Loss. A common problem in source separation is forcing the separated signal frames belonging to the same speaker to be aligned with the same output stream. Unlike the Permutation Invariant Loss (PIT) which is applied to each input frame independently, the uPIT is applied to the whole sequence at once. This modification greatly improves the amount of occurrences in which the output is flipped between the different sources. However, according to the experiments disclosed herein this is still a far from being optimal.

To mitigate that, the embodiments disclosed herein propose to add an additional loss function which imposes a long-term dependency on the output streams. In particular embodiments, the computing system may order, based on the permutation, the second number of output channels. The computing system may then apply an identity loss function to the ordered output channels. In particular embodiments, the computing system may further identify speakers associated with the ordered output channels, respectively. For this purpose, the embodiments disclosed herein use a speaker recognition model that the embodiments disclosed herein train to identify the persons in the training set. Once this neural network is trained, the embodiments disclosed herein minimize the L2 distance between the network embeddings of the predicted audio channel and the corresponding source.

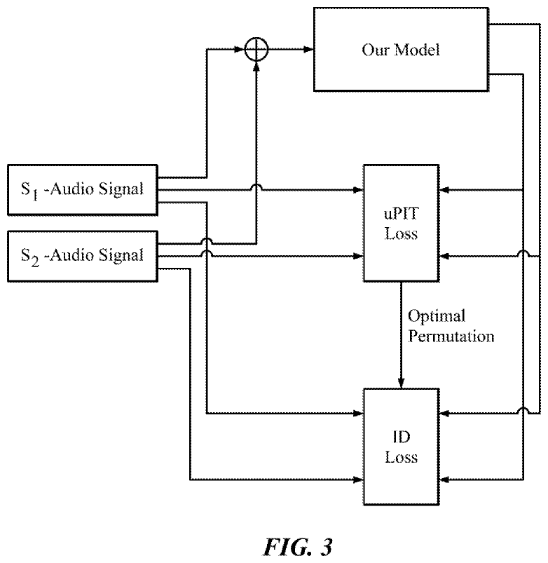

FIG. 3 illustrates example training losses used in the embodiments disclosed herein, shown for the case of two speakers. As the speaker recognition model, the embodiments disclosed herein use the VGG11 network trained on the power spectrograms (STFT) obtained from 0.5 sec of audio. Denote the embedding obtained from the penultimate layer of the trained VGG network by G. The embodiments disclosed herein used it in order to compare segments of length 0.5 sec of the ground truth audio sᵢ with the output audio ŝ_{π(i)}, where π is the optimal permutation obtained from the uPIT loss, see FIG. 3. In FIG. 3, the mixed signal x combines the two input voices s₁ and s₂. The model disclosed herein then separates to create two output channels ŝ₁ and ŝ₂. The permutation invariant SI-SNR loss computes the SI-SNR between the ground truth channels and the output channels, obtained at the channel permutation π that minimizes the loss. The identity loss is then applied to the matching channels, after they have been ordered by π.

Let sᵢ^{j} be the j-th segments of length 0.5 sec obtained by cropping audio sequence s₁, and similarly ŝᵢ^{j} for s₁. The identity loss is given by

$$ℓ ( s , \hat{s} ) = \frac{1}{C \vert J ( s ) \vert} {\sum }_{i = 1}^{C} {\sum }_{j = 1}^{J ( s )} MSE ( G ( F ( {s}_{i}^{j} ) ) , G ( F ( {\hat{s}}_{i}^{j} ) ) ) \qquad ( 6 )$$

where J(s) is the number of segments extracted from s and F is a differential STFT implementation, i.e., a network implementation of STFT that allows us to back-propagate the gradient though it.

The embodiments disclosed herein train a different model for each number of audio components in the mix C. This allows us to directly compare with the baseline methods. However, in order to apply the method in practice, it is important to be able to select the number of speakers. In particular embodiments, the second number configured for the second machine-learning model may equal to a number of the plurality of speakers. Accordingly, the computing system may generate, by the second machine-learning model, a plurality of audio signals. In particular embodiments, each audio signal may comprise a voice signal associated with a distinct speaker from the plurality of speakers.

While it is possible to train a classifier to determine C given a mixed audio, the embodiments disclosed herein opt for a non-learned solution in order to avoid biases that arise from the distribution of data and to promote solutions in which the separation models are not detached from the selection process.

In particular embodiments, the computing system may determine that the at least one output channel is silent is based on a speech activity detector. The procedure the embodiments disclosed herein employ is based on the speech activity detector of Librosa python package.

Starting from the model that was trained on the dataset with the largest number of speakers C, the embodiments disclosed herein apply the speech detector to each output channel. If the embodiments disclosed herein detect silence (no-activity) in one of the channels, the embodiments disclosed herein move to the model with C−1 output channels and repeat the process until all output channels contain speech.

As can be seen in the experiments disclosed herein, this selection procedure may be relatively accurate and lead to results with an unknown number of speakers that are only moderately worse than the results when this parameter is known.

In the experiments, the embodiments disclosed herein employ the WSJ0-2mix and WSJ0-3mix datasets (i.e., two public datasets) and the embodiments disclosed herein further expand the WSJ-mix dataset to four and five speakers and introduce WSJ0-4mix and WSJ0-5mix datasets. The embodiments disclosed herein use 30 hours of speech from the training set si_tr_s to create the training and validation sets. The four and five speakers were randomly chosen and combined with random SNR values between 0-5 [dB]. The test set is created from si_et_s and si_dt_s with 16 speakers, that differ from the speakers of the training set. A separate model is trained for each dataset, with the corresponding number of output channels.

Implementation details The embodiments disclosed herein choose hyper parameters based on the validation set. The input kernel size L was 8 (except for the experiment where the embodiments disclosed herein vary it) and the number of the filter in the preliminary convolutional layer was 128. The embodiments disclosed herein use an audio segment of four seconds long sampled at 8 kHz. The architecture uses b=6 blocks of MULCAT, where each LSTM layer contains 128 neurons. The embodiments disclosed herein multiply the IDloss with 0.001 when combined the uPIT loss. The learning rate was set to 5e−4, which was multiplying by 0.98 every two epoches. The ADAM optimizer (i.e., a conventional optimizer) was used with batch size of 2. For the speaker model, the embodiments disclosed herein extract the STFT using a window size of 20 ms with stride of 10 ms and Hamming window.

In order to evaluate the proposed model, the embodiments disclosed herein report the scale-invariant signal-to-noise ratio improvement (SI-SNRi) score on the test set, computed as follows,

$$SI - SNR ( s , \hat{s} , x ) = \frac{1}{c} {\sum }_{i = 1}^{C} SI - SNR ( {s}_{i} , {\hat{s}}_{i} ) - SI - SNR ( {s}_{i ,} , x ) \qquad ( 7 )$$

The embodiments disclosed herein compare with the following baseline methods: ADANet, DPCL++, CBLDNN-GAT, TasNet, the Ideal Ratio Mask (IRM), ConvTasNet, FurcaNeXt, and DPRNN. Prior work, often reported the signal-to-distortion ratio (SDR). However, recent studies have argued that the aforementioned metric has been improperly used due to its scale dependence and may result in misleading findings.

The results are reported in Table 1. Each column depicts a different dataset, where the number of speakers C in the mixed signal x is different. The model used for evaluating each dataset is the model that was trained to separate the same number of speakers. As can be seen, the disclosed model is superior to previous methods by a sizable margin, in all four datasets.

TABLE 1
Performance of various models as a function of the number
of speakers. Starred results (*) mark our training, using
published code by the method's authors. The other baselines
are obtained from the respective work.

| Model | 2spk | 3spk | 4spk | 5spk |
|---|---|---|---|---|
| ADANet | 10.5 | 9.1 | — | — |
| DPCL++ | 10.8 | 7.1 | — | — |
| CBLDNN-GAT | 11 | — | — | — |
| TasNet | 11.2 | — | — | — |
| IRM | 12.7 | — | — | — |
| ConvTasNet | 15.3 | 12.7 | 8.51* | 6.80* |
| FurcaNeXt | 18.4 | — | — | — |
| DPRNN | 18.8 | 14.72* | 10.37* | 8.35* |
| Ours | 20.12 | 16.85 | 12.88 | 10.56 |

In order to understand the contribution of each of the various components in the proposed method, the embodiments disclosed herein conducted an ablation study. (i) The embodiments disclosed herein replace the MULCAT block with a conventional LSTM (“-gating”); (ii) the embodiments disclosed herein train with a permutation invariant loss that is applied only at the final output (“-multiloss”) of the model; and (iii) the embodiments disclosed herein train with and without the identity loss (“-IDloss”).

First, the embodiments disclosed herein analyzed the importance of each loss term to the final model performance. Table 2 summarizes the results. As can be seen, each of aforementioned components contributes to the performance gain of the disclosed method, with the multi-layer loss being more dominant than the others. Adding the identity loss to the DPRNN model also yields a performance improvement. The embodiments disclosed herein would like to stress that not only being different in the multiply and concat block, the identity loss and the multiscale loss, the disclosed method may not employ a mask when performing separation and instead directly generates the separated signals.

TABLE 2
Ablation analysis where the embodiments disclosed herein take
out the two LSTM structures and replace them with a single one
(-gating), remove the multiloss (- multiloss), or remove the
speaker identification loss (-IDloss). The embodiments disclosed
herein also present the results of adding the identification
loss to the baseline DPRNN method. The DPRNN results are based
on our training, using the authors' published code.

| Model | 2spk | 3spk | 4spk | 5spk |
|---|---|---|---|---|
| DPRNN | 18.08 | 14.72 | 10.37 | 8.35 |
| DPRNN + IDloss | 18.42 | 14.91 | 11.29 | 9.01 |
| Ours-gating-multiloss-IDloss | 19.02 | 14.88 | 10.76 | 8.42 |
| Ours-gating -IDloss | 19.30 | 15.60 | 11.06 | 8.84 |
| Ours-multiloss-IDloss | 18.84 | 13.73 | 10.40 | 8.65 |
| Ours-IDloss | 19.76 | 16.63 | 12.60 | 10.20 |
| Ours | 20.12 | 16.70 | 12.82 | 10.50 |

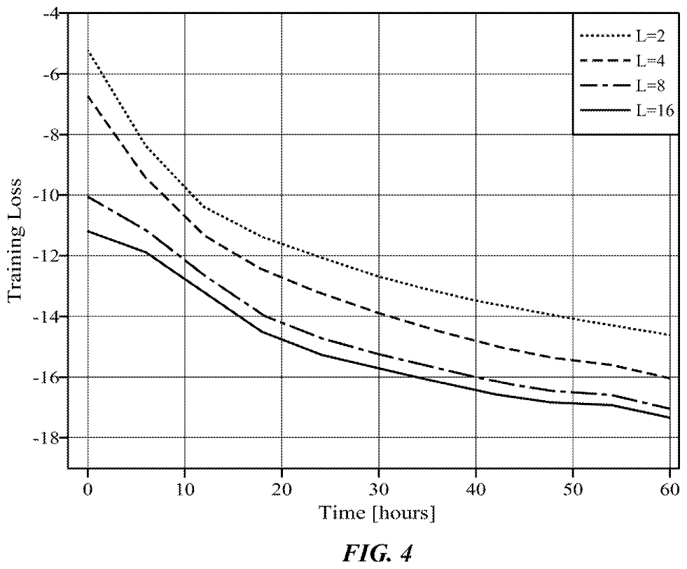

FIG. 4 illustrates example training curves of the disclosed model for various kernel sizes. Recent studies pointed out the importance of choosing small kernel size for the encoder. In ConvTasNet the authors suggest that kernel size L of 16 performs better than larger ones, while the authors of DPRNN advocate for an even smaller size of L=2. Table 3 shows that unlike DPRNN, the performance of the disclosed model may be not harmed by larger kernel sizes. FIG. 4 depicts the convergence rates of the disclosed model for various L values for the first 60 hours of training. Being able to train with kernels with L>2 leads to faster convergence to results at the range of recently published methods.

TABLE 3
Performance of three types of models as a function of the kernel
size. The disclosed model may not suffer from changing the
kernel size. (Only the last row is based on our runs).

| Model | L = 2 | L = 4 | L = 8 | L = 16 |
|---|---|---|---|---|
| ConvTasNet | — | — | — | 15.3 |
| DPRNN | 18.8 | 17.9 | 17.0 | 15.9 |
| Ours | 18.94 | 19.91 | 19.76 | 18.16 |

Lastly, the embodiments disclosed herein explored the effect of the identity loss. Recall that the identity loss is meant to reduce the frequency in which an output channel switches between the different speaker identities. In order to measure the frequency of this event, the embodiments disclosed herein have separated the audio into sub-clips of length 0.25 sec and tested the best match, using SI-SNR, between each segment and the target speakers. If the matching switched from one voice to another, the embodiments disclosed herein marked the entire sample as a switching sample.

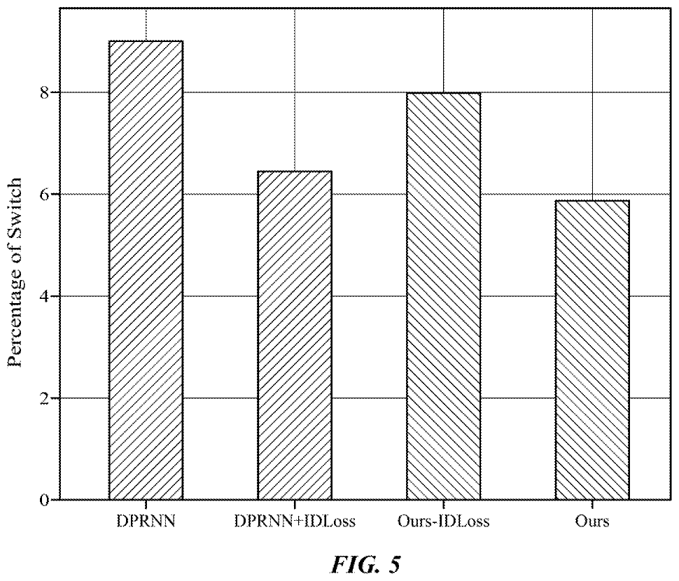

FIG. 5 illustrates an example fraction of samples in which the model produces output channels with an identity switch, using the dataset of two speakers. The results suggest that both DPRNN and the proposed model benefit from the incorporation of the identity loss. However, this loss may not eliminate the problem completely. The results are depicted in FIG. 5.

The embodiments disclosed herein found out that starting the separation at different points in time yields slightly different results. For this purpose, the embodiments disclosed herein cut the mixed audio at a certain time point and then concatenate the first part at the end of the second. Performing this multiple times, at random starting points and then averaging the results tends to improve results.

The averaging process is as follows: first, the original starting point is restored by inverting the shifting process. Then, the channels are then matched (using MSE) to a reference set of channels, finding the optimal permutation. In the experiments, the embodiments disclosed herein use the separation results of the original mixed signal as the reference signal. The results from all starting points are then averaged.

Table 4 depicts the results for both the disclosed method and DPRNN. Evidently, as the number of random shifts increases, the performance improves. To clarify: in order to allow a direct comparison with the literature, the results reported elsewhere in the embodiments disclosed herein are obtained without this augmentation.

TABLE 4
The results of performing test-time augmentation. The x-
axis is the number of shifted versions that were averaged,
at inference time, to obtain the final output. The y-axis
is the SI-SNRi obtained by this process. DPRNN results
are obtained by running the published training code.

| | Number of augmentations | | | | | | |
|---|---|---|---|---|---|---|---|
| Model | 0 | 3 | 5 | 7 | 10 | 15 | 20 |
| DPRNN(2spk) | 18.08 | 18.11 | 18.15 | 18.18 | 18.19 | 18.19 | 18.21 |
| Ours(2spk) | 20.12 | 20.16 | 20.24 | 20.26 | 20.29 | 20.3 | 20.31 |
| DPRNN(3spk) | 14.72 | 15.06 | 15.14 | 15.18 | 15.21 | 15.24 | 15.25 |
| Ours(3spk) | 16.71 | 16.86 | 16.93 | 16.96 | 16.99 | 17.01 | 17.01 |
| DPRNN(4spk) | 10.37 | 10.49 | 10.53 | 10.54 | 10.56 | 10.57 | 10.58 |
| Ours(4spk) | 12.88 | 12.91 | 13 | 13.04 | 13.05 | 13.11 | 13.11 |
| DPRNN(5spk) | 8.35 | 8.85 | 8.87 | 8.89 | 8.9 | 8.91 | 8.91 |
| Ours(5spk) | 10.56 | 10.72 | 10.8 | 10.84 | 10.88 | 10.92 | 10.93 |

When there are C speakers in a given mixed audio x, one may employ a model that was trained on C″>C speakers. In this case, the superfluous channels seem to produce relatively silent signals for both the disclosed method and DPRNN. One can then match the C″ output channels to the C channels in the optimal way, discarding C″−C channels, and compute the SI-SNRi score. Table 5 depicts the results for DPRNN and the disclosed method. As can be seen, the level of results obtained is the same level obtained by the C″ model when applied to C″ speakers, or slightly better (the mixture audio is less confusing if there are less speakers).

TABLE 5
The results of evaluating models with at least the number of required output
channels on the datasets where the mixes contain 2, 3, 4, and 5 speakers,
(a) DPRNN (our training using the authors' published code), (b) Our model.

| | (a) | | | | | (b) | | | |
|---|---|---|---|---|---|---|---|---|---|
| | Num. speakers in mixed sample | | | | | Num. speakers in mixed sample | | | |
| DPRNN model | 2 | 3 | 4 | 5 | Our model | 2 | 3 | 4 | 5 |
| 2-speaker model | 18.08 | — | — | — | 2-speaker model | 20.12 | — | — | — |
| 3-speaker model | 13.47 | 14.7 | — | — | 3-speaker model | 15.63 | 16.70 | — | — |
| 4-speaker model | 10.77 | 11.96 | 10.88 | — | 4-speaker model | 13.25 | 13.46 | 12.82 | — |
| 5-speaker model | 7.62 | 9.76 | 9.48 | 8.65 | 5-speaker model | 11.02 | 11.81 | 11.21 | 10.50 |

The embodiments disclosed herein next apply the disclosed model selection method, which automatically selects the most appropriate model, based on a voice activity detector. The embodiments disclosed herein consider a silence channel if more than half of it was detected as silence by the detector. For a fair comparison the embodiments disclosed herein calibrated the threshold for silence detection to each method separately. The embodiments disclosed herein evaluate the disclosed method, using a confusion matrix, whether this unlearned method is effective in accurate in estimating the number of speakers. Additionally, the embodiments disclosed herein measure the obtained SI-SNRi when using the selected model and compare it to the oracle (known number of speakers in the recording).

As can be seen in Table 6, simply by looking for silent output channels, the embodiments disclosed herein are able to identify the number of speakers in a large portion of the cases for our method. In terms of SI-SNRi, with the exception of the two-speaker dataset, the automatic selection is slightly inferior to using the 5-speaker model. In the case of two speakers, using the automatic selection procedure is considerably preferable.

For DPRNN, the accuracy of selecting the correct model is lower on average the overall SI-SNRi results are lower than those of our model.

TABLE 6
Results of automatically selecting the number of speakers C for a mixed sample
x. Shown are both the confusion matrix and the SI-SNRi results obtained using
automatic model selection, in comparison to the results obtained when the
number of speakers in the mixture is given, (a) DPRNN, (b) Our model.

| | (a) | | | | | (b) | | | |
|---|---|---|---|---|---|---|---|---|---|
| | Num. speakers in mixed sample | | | | | Num. speakers in mixed sample | | | |
| DPRBB model | 2 | 3 | 4 | 5 | Our model | 2 | 3 | 4 | 5 |
| 2spk | 21% | 8% | 1% | 0.2% | 2spk | 37% | 28% | 6% | 0.5% |
| 3spk | 33% | 25% | 7% | 2% | 3spk | 31% | 41% | 26% | 7% |
| 4spk | 27% | 38% | 30% | 17% | 4spk | 26% | 28% | 47% | 31% |
| 5spk | 20% | 28% | 63% | 81% | 5spk | 6% | 3% | 21% | 62% |
| Ours auto-select | 13.44 | 11.01 | 9.68 | 8.37 | Ours auto-select | 16.62 | 11.13 | 10.30 | 9.43 |
| Ours known C | 18.21 | 14.71 | 10.37 | 8.65 | Ours known C | 20.12 | 16.70 | 12.82 | 10.50 |

From a broad perceptual perspective, the cocktail party problem is a difficult instance segmentation problem with many occluding instances. The instances cannot be separated due to continuity alone, since speech signals contain silent parts, calling for the use of an identification-based constancy loss. The embodiments disclosed herein add this component and also use it in order to detect the number of instances in the mixed signal, which is a capability that is missing in the current literature.

Unlike previous work, in which the performance degrades rapidly as the number of speakers increases, even for a known number of speakers, the embodiments disclosed herein provide a practical solution. This is achieved by introducing a new recurrent block, which combines two bi-directional RNNs and a skip connection, the use of multiple losses, and a voice constancy term mentioned above. The obtained results are better than all existing method, in a rapidly evolving research domain, by sizable gap.

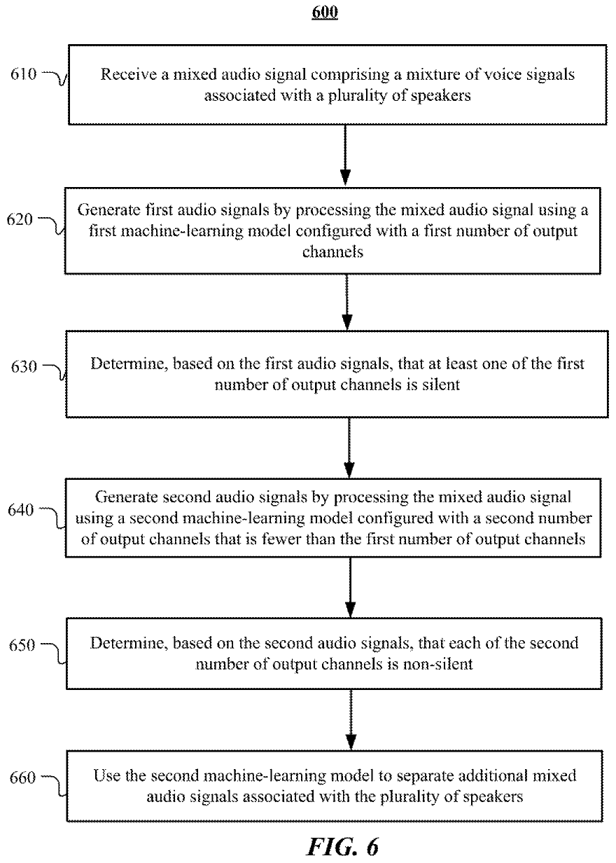

FIG. 6 illustrates an example method 600 for separating mixed voice signals. The method may begin at step 610, where a computing system may receive a mixed audio signal comprising a mixture of voice signals associated with a plurality of speakers. At step 620, the computing system may generate first audio signals by processing the mixed audio signal using a first machine-learning model configured with a first number of output channels. At step 630, the computing system may determine, based on the first audio signals, that at least one of the first number of output channels is silent. At step 640, the computing system may generate second audio signals by processing the mixed audio signal using a second machine-learning model configured with a second number of output channels that is fewer than the first number of output channels. At step 650, the computing system may determine, based on the second audio signals, that each of the second number of output channels is non-silent. At step 660, the computing system may use the second machine-learning model to separate additional mixed audio signals associated with the plurality of speakers. Particular embodiments may repeat one or more steps of the method of FIG. 6, where appropriate. Although this disclosure describes and illustrates particular steps of the method of FIG. 6 as occurring in a particular order, this disclosure contemplates any suitable steps of the method of FIG. 6 occurring in any suitable order. Moreover, although this disclosure describes and illustrates an example method for separating mixed voice signals including the particular steps of the method of FIG. 6, this disclosure contemplates any suitable method for separating mixed voice signals including any suitable steps, which may include all, some, or none of the steps of the method of FIG. 6, where appropriate. Furthermore, although this disclosure describes and illustrates particular components, devices, or systems carrying out particular steps of the method of FIG. 6, this disclosure contemplates any suitable combination of any suitable components, devices, or systems carrying out any suitable steps of the method of FIG. 6.

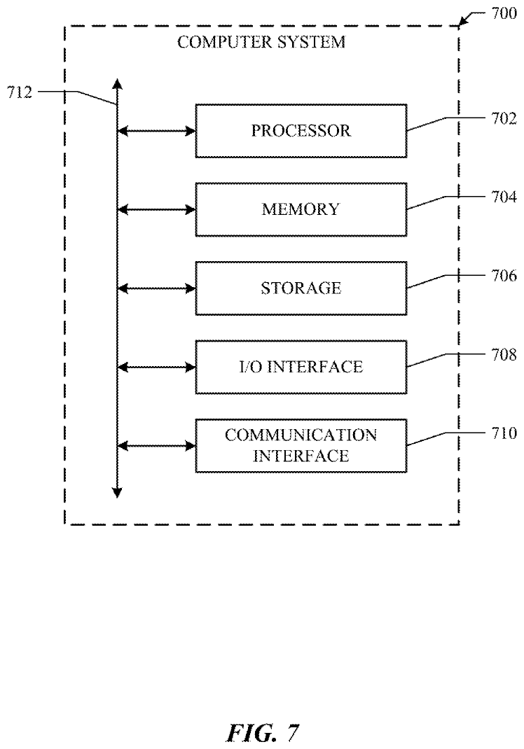

FIG. 7 illustrates an example computer system 700. In particular embodiments, one or more computer systems 700 perform one or more steps of one or more methods described or illustrated herein. In particular embodiments, one or more computer systems 700 provide functionality described or illustrated herein. In particular embodiments, software running on one or more computer systems 700 performs one or more steps of one or more methods described or illustrated herein or provides functionality described or illustrated herein. Particular embodiments include one or more portions of one or more computer systems 700. Herein, reference to a computer system may encompass a computing device, and vice versa, where appropriate. Moreover, reference to a computer system may encompass one or more computer systems, where appropriate.

This disclosure contemplates any suitable number of computer systems 700. This disclosure contemplates computer system 700 taking any suitable physical form. As example and not by way of limitation, computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 700 may include one or more computer systems 700; be unitary or distributed; span multiple locations; span multiple machines; span multiple data centers; or reside in a cloud, which may include one or more cloud components in one or more networks. Where appropriate, one or more computer systems 700 may perform without substantial spatial or temporal limitation one or more steps of one or more methods described or illustrated herein. As an example and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

In particular embodiments, computer system 700 includes a processor 702, memory 704, storage 706, an input/output (I/O) interface 708, a communication interface 710, and a bus 712. Although this disclosure describes and illustrates a particular computer system having a particular number of particular components in a particular arrangement, this disclosure contemplates any suitable computer system having any suitable number of any suitable components in any suitable arrangement.

In particular embodiments, processor 702 includes hardware for executing instructions, such as those making up a computer program. As an example and not by way of limitation, to execute instructions, processor 702 may retrieve (or fetch) the instructions from an internal register, an internal cache, memory 704, or storage 706; decode and execute them; and then write one or more results to an internal register, an internal cache, memory 704, or storage 706. In particular embodiments, processor 702 may include one or more internal caches for data, instructions, or addresses. This disclosure contemplates processor 702 including any suitable number of any suitable internal caches, where appropriate. As an example and not by way of limitation, processor 702 may include one or more instruction caches, one or more data caches, and one or more translation lookaside buffers (TLBs). Instructions in the instruction caches may be copies of instructions in memory 704 or storage 706, and the instruction caches may speed up retrieval of those instructions by processor 702. Data in the data caches may be copies of data in memory 704 or storage 706 for instructions executing at processor 702 to operate on; the results of previous instructions executed at processor 702 for access by subsequent instructions executing at processor 702 or for writing to memory 704 or storage 706; or other suitable data. The data caches may speed up read or write operations by processor 702. The TLBs may speed up virtual-address translation for processor 702. In particular embodiments, processor 702 may include one or more internal registers for data, instructions, or addresses. This disclosure contemplates processor 702 including any suitable number of any suitable internal registers, where appropriate. Where appropriate, processor 702 may include one or more arithmetic logic units (ALUs); be a multi-core processor; or include one or more processors 702. Although this disclosure describes and illustrates a particular processor, this disclosure contemplates any suitable processor.

In particular embodiments, memory 704 includes main memory for storing instructions for processor 702 to execute or data for processor 702 to operate on. As an example and not by way of limitation, computer system 700 may load instructions from storage 706 or another source (such as, for example, another computer system 700) to memory 704. Processor 702 may then load the instructions from memory 704 to an internal register or internal cache. To execute the instructions, processor 702 may retrieve the instructions from the internal register or internal cache and decode them. During or after execution of the instructions, processor 702 may write one or more results (which may be intermediate or final results) to the internal register or internal cache. Processor 702 may then write one or more of those results to memory 704. In particular embodiments, processor 702 executes only instructions in one or more internal registers or internal caches or in memory 704 (as opposed to storage 706 or elsewhere) and operates only on data in one or more internal registers or internal caches or in memory 704 (as opposed to storage 706 or elsewhere). One or more memory buses (which may each include an address bus and a data bus) may couple processor 702 to memory 704. Bus 712 may include one or more memory buses, as described below. In particular embodiments, one or more memory management units (MMUs) reside between processor 702 and memory 704 and facilitate accesses to memory 704 requested by processor 702. In particular embodiments, memory 704 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 704 may include one or more memories 704, where appropriate. Although this disclosure describes and illustrates particular memory, this disclosure contemplates any suitable memory.

In particular embodiments, storage 706 includes mass storage for data or instructions. As an example and not by way of limitation, storage 706 may include a hard disk drive (HDD), a floppy disk drive, flash memory, an optical disc, a magneto-optical disc, magnetic tape, or a Universal Serial Bus (USB) drive or a combination of two or more of these. Storage 706 may include removable or non-removable (or fixed) media, where appropriate. Storage 706 may be internal or external to computer system 700, where appropriate. In particular embodiments, storage 706 is non-volatile, solid-state memory. In particular embodiments, storage 706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 706 taking any suitable physical form. Storage 706 may include one or more storage control units facilitating communication between processor 702 and storage 706, where appropriate. Where appropriate, storage 706 may include one or more storages 706. Although this disclosure describes and illustrates particular storage, this disclosure contemplates any suitable storage.

In particular embodiments, I/O interface 708 includes hardware, software, or both, providing one or more interfaces for communication between computer system 700 and one or more I/O devices. Computer system 700 may include one or more of these I/O devices, where appropriate. One or more of these I/O devices may enable communication between a person and computer system 700. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 708 for them. Where appropriate, I/O interface 708 may include one or more device or software drivers enabling processor 702 to drive one or more of these I/O devices. I/O interface 708 may include one or more I/O interfaces 708, where appropriate. Although this disclosure describes and illustrates a particular I/O interface, this disclosure contemplates any suitable I/O interface.

In particular embodiments, communication interface 710 includes hardware, software, or both providing one or more interfaces for communication (such as, for example, packet-based communication) between computer system 700 and one or more other computer systems 700 or one or more networks. As an example and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 710 for it. As an example and not by way of limitation, computer system 700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 700 may include any suitable communication interface 710 for any of these networks, where appropriate. Communication interface 710 may include one or more communication interfaces 710, where appropriate. Although this disclosure describes and illustrates a particular communication interface, this disclosure contemplates any suitable communication interface.

In particular embodiments, bus 712 includes hardware, software, or both coupling components of computer system 700 to each other. As an example and not by way of limitation, bus 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 712 may include one or more buses 712, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by one or more computing systems:
receiving a mixed audio signal comprising a mixture of voice signals associated with a plurality of speakers;
generating first audio signals by processing the mixed audio signal using a first machine-learning model configured with a first number of output channels;
determining, based on the first audio signals, that at least one of the first number of output channels is silent;
generating second audio signals by processing the mixed audio signal using a second machine-learning model configured with a second number of output channels that is fewer than the first number of output channels;
determining, based on the second audio signals, that each of the second number of output channels is non-silent; and
using the second machine-learning model to separate additional mixed audio signals associated with the plurality of speakers.

2. The method of claim 1, wherein a number of the plurality of speakers is unknown.

3. The method of claim 1, wherein the second number equals to a number of the plurality of speakers.

4. The method of claim 1, further comprising:
generating, by the second machine-learning model, a plurality of audio signals, each audio signal comprising a voice signal associated with a distinct speaker from the plurality of speakers.

5. The method of claim 1, wherein the first machine-learning model and the second machine-learning model are each based on one or more neural networks.

6. The method of claim 1, further comprising:
encoding the mixed audio signal to generate a latent representation; and
generating a three-dimensional (3D) tensor based on the latent representation, wherein the generation comprises:

7. The method of claim 6, wherein encoding the mixed audio signal is based on one or more convolution operations.

8. The method of claim 6, wherein generating the 3D tensor comprises:
dividing the latent representation into a plurality of overlapping chunks; and
concatenating the plurality of overlapping chunks along one or more singleton dimensions.

9. The method of claim 1, wherein the first machine-learning model and the second machine-learning model are each based on one or more multiply-and-concatenation (MULCAT) blocks, each MULCAT block comprising one or more of a long-short term memory (LSTM) unit, a concatenation operation, a linear projection, or a permutation operation.

10. The method of claim 1, further comprising:
determining a permutation for the second number of output channels based on a permutation invariant loss function.

11. The method of claim 10, further comprising:
ordering, based on the permutation, the second number of output channels;
applying an identity loss function to the ordered output channels; and
identifying speakers associated with the ordered output channels, respectively.

12. The method of claim 1, wherein determining that the at least one output channel is silent is based on a speech activity detector.

13. The method of claim 1, wherein the first machine-learning model and the second machine-learning model are each trained based on a plurality of mixed audio signals and a plurality of audio signals associated with each of the plurality of speakers, wherein each mixed audio signal comprising a mixture of voice signals associated with the plurality of speakers.

14. One or more computer-readable non-transitory storage media embodying software that is operable when executed to:
receive a mixed audio signal comprising a mixture of voice signals associated with a plurality of speakers;
generate first audio signals by processing the mixed audio signal using a first machine-learning model configured with a first number of output channels;
determine, based on the first audio signals, that at least one of the first number of output channels is silent;
generate second audio signals by processing the mixed audio signal using a second machine-learning model configured with a second number of output channels that is fewer than the first number of output channels;
determine, based on the second audio signals, that each of the second number of output channels is non-silent; and
use the second machine-learning model to separate additional mixed audio signals associated with the plurality of speakers.

15. The media of claim 14, wherein a number of the plurality of speakers is unknown.

16. The media of claim 14, wherein the second number equals to a number of the plurality of speakers.

17. The media of claim 14, wherein the software is further operable when executed to:
generate, by the second machine-learning model, a plurality of audio signals, each audio signal comprising a voice signal associated with a distinct speaker from the plurality of speakers.

18. The media of claim 14, wherein the first machine-learning model and the second machine-learning model are each based on one or more neural networks.

19. The media of claim 14, wherein the first machine-learning model and the second machine-learning model are each based on one or more multiply-and-concatenation (MULCAT) blocks, each MULCAT block comprising one or more of a long-short term memory (LSTM) unit, a concatenation operation, a linear projection, or a permutation operation.

20. A system comprising: one or more processors; and a non-transitory memory coupled to the processors comprising instructions executable by the processors, the processors operable when executing the instructions to:
receive a mixed audio signal comprising a mixture of voice signals associated with a plurality of speakers;
generate first audio signals by processing the mixed audio signal using a first machine-learning model configured with a first number of output channels;
determine, based on the first audio signals, that at least one of the first number of output channels is silent;
generate second audio signals by processing the mixed audio signal using a second machine-learning model configured with a second number of output channels that is fewer than the first number of output channels;
determine, based on the second audio signals, that each of the second number of output channels is non-silent; and
use the second machine-learning model to separate additional mixed audio signals associated with the plurality of speakers.
